(19) United States
(12) Patent Application Publication
(10) Pub. No.: US 2003/0232530 A1
(43) Pub. Date: Dec. 18, 2003

(54) Modular power assemblies for electronic devices

(75) Inventors: Fidel P. Vista JR., Las Pinas City (PH); Ceferino Agonoy Sanchez III, Kapitolyo Pasig City (PH); Steven Lee Willing, Encinitas, CA (US)

Correspondence Address: COUDERT BROTHERS LLP, 600 Beach Street, 3rd Floor, San Francisco, CA, 94109, US

(73) Assignee: Astec International Limited, KWUN TONG (HK)

(21) Appl. No.: 10/172,194

(22) Filed: Jun. 14, 2002

(51) Int. Cl. H01R 29/00; H02J 7/00; H02J 9/00

(52) U.S. Cl. 439/170; 307/150

(57) ABSTRACT

The present invention provides a system and method for providing power to electronic devices such as cellular telephones and accessories thereof. A power converter module, which may be either an AC or DC module and which delivers accessory usable power, mates with an accessory module through a pair of mating connectors. By supplying a standard interface between converter and accessory modules, a system of interchangeable modules can be used to produce accessories without duplication of what would otherwise be redundant components. The invention thus provides flexibility and reduces the cost and clutter of prior art systems and methods for powering cell phone accessories.

### FIELD OF THE INVENTION

The present invention relates to devices for coupling power supplies to electronic devices and, in particular, to modular systems allowing for the interchangeability of various cellular telephone accessory components with either AC or DC power converters.

### BACKGROUND OF THE INVENTION

Accessories for cellular telephones (“cell phone accessories”) provide power to charge or operate a cell phone or charge spare batteries, and can also power hands-free communication devices or other useful features or functions. In general, cell phone accessories provide mechanical and electrical coupling between a power source and a powered device. Cell phone accessory power is usually obtained from either an AC or DC power receptacle using a mating component, usually a plug. The cell phone accessory output voltage is usually provided to powered devices by a plug or stand. Power can be provided to a battery through a charging station adapted to receive the battery. In addition to receiving power, cabling that provides power to a phone can also pass or amplify other signals, such as speaker or microphone signals between the phone and other accessories, such as conference call speakers. Cell phone accessories also typically include electronics to convert the source power to an accessory-compatible, DC output voltage.

Typical prior art accessory power supplies include the following components in a single unit: a plug for coupling to a power supply receptacle, a connector for coupling to a cell phone, battery or other device, and power conversion electronics between the plug and connector, and may include one or more cables. Accessory power supplies thus provide a connection between the source power and the cell phone, battery or other accessories and delivers the power in a form that is usable by the accessories, usually an output DC voltage in the range of 5 to 26 volts. Particularly useful devices include car chargers, which are adapted to plug into an automobile's cigarette lighter receptacle, trickle or fast chargers, which are adapted to plug into a standard power receptacle, travel chargers which are adapted for plugging into and converting the power from several of the international AC power standard voltages and connectors, and accessories such as conference call speakers.

Accessories for operating or charging cell phones can include either a plug-type connector, where a cord end includes a plug that connects with a cell phone, or with a cradle-type connector having a stand for supporting the cell phone while providing the necessary electrical contacts. The plug-type connector forms an electrical connection through a plug adapted for mating telephone power input connector. The cable for such a device can be chosen from several electrically equivalent cables, such as a straight cord, a retractable cord, or a coiled cord.

The cradle-type connector supports a phone in a generally upright orientation. The phone and cradle combination has a specific mating configuration that provides electrical connects are formed between pins, springs, or flat areas one the phone and cradle. In some systems the cradle is separate from the DC power cord, and is connected to the cradle using a conventional standard DC connector. In another prior art car charger cradle-type connector, the cradle, power converter and power source adaptor are a single unit, such that the cellular telephone may be placed into a charging cradle which is plugged into the cigarette lighter of the automobile.

In general, prior art systems are either integral or configured for connection from a specific type of power source to a specific other cellular telephone accessory. Since it is generally recognized that cell phones are more useful when the user has the flexibility of powering the cell phone or accessories from more than one power source, or in conjunction with more than one cell phone or accessory, many cell phone users have several accessory power supplies. Due to the variety of power sources, most of which have standardized connectors, and the number of cell phones and accessories, whose connectors are not standardized, there is a multitude of accessory power supplies available for the cell phone user. Thus, a consumer who wishes to have a car charger or a desktop charger must purchase a system that includes each of the accessory power supply components. While the prior art provides specialized cell phone power devices that seemingly meet any need, this approach has several disadvantages. First, a cell phone user who wishes to have more than one cell phone powering device must content with a several devices which are bulky and usually have long cords. Users having more than one cell phone will require multiple accessory power supplies. Second, each of the accessory power supplies necessarily has components that are duplicative of either mechanical or electrical components. Thus for example, each charging device for an automobile will have a cigarette adaptor and a DC-DC converter, and each charging device may have similar cords with telephone power adapters. As a result, the each cell phone requires many accessory power supplies, which can be difficult to store or confusing due to similarities between the various supplies.

What is needed is a cell phone charging device system that permits a cell phone user to have the functionality of multiple devices without the duplication of heavy or bulky components, or of having to contend with multiple long cords. Such a system should also allow the cell phone user the maximum flexibility to use the various components in a variety of settings.

### BRIEF SUMMARY OF THE INVENTION

The present invention solves the above-identified problems of known devices by providing methods and systems of modular units for supplying power for cellular telephone accessories. In accordance with the present invention, power is provided by two or more modular units that can interchangeably be connected between one or more accessory and one of several power sources.

Broadly stated, the present invention is directed to a modular system for accepting power from a power source receptacle and providing power of specified characteristics to an electronic device. It is one aspect of the present invention to provide a modular system for accepting power from a receptacle of a power source, and providing power of specified characteristics to an electronic device. The system includes a converter module including a housing, where the housing supports a plug adapted to mate with the receptacle, a first connector, and electronics that are disposed between the plug and the first connector and adapted to convert power from the mated plug to the specified power characteristics. The system also includes an accessory module having a second connector adapted to mate with and be supported by the first connector, and an assembly adapted to mate with the electronic device.

It is another aspect of the present invention to provide a converter module connectable to a power receptacle of a power source and an accessory module having a second connector and adapted to provide power of specified characteristics to an electronic device. The converter module includes a housing to support a plug adapted to mate with the receptacle, a first connector, and electronics disposed between said plug and said connector. The electronics are adapted to convert the power from the mated plug to the specified power characteristics, and the connector is adapted to mate with and support the second connector of one of a plurality of accessory modules.

It is yet another aspect of the present invention to provide an accessory module to accept power at specified characteristics to an electronic device, said accepted power provide by a converter module having a plug adapted to receive power from a receptacle of a power source. The converter module includes a housing to support a plug adapted to connect to the receptacle, a first connector, and electronics disposed between the plug and the first connector to convert the power from a plug connected to the receptacle. The accessory modules includes a second connector adapted to mate with and be supported by the first connector, and an assembly adapted to mate with the electronic device.

It is another aspect of the present invention to provide a method for providing interchangeably of accessories for cellular telephones and power sources comprising providing a connector to a power converter that is connectable to one of a plurality of cellular telephone accessories.

It is yet another aspect of the present invention to provide a method for providing interchangeably of accessories for cellular telephones and power sources comprising providing a connector to a cellular telephone accessory module power that is connectable to one of a plurality of power converters.

It is thus an advantage of the present invention to provide methods and systems for connecting accessories to power sources that can be configured by a user. Another advantage of the present invention is that it provides methods and systems for connecting accessories to power sources with greater flexibility for the user, and which allow for multiple configurations without the need for many components that would be redundant between the multiple configurations.

A further understanding of the invention can be had from the detailed discussion of specific embodiments below. For purposes of clarity, this discussion refers to devices, methods, and concepts in terms of specific examples. However, the method of the present invention may operate with a wide variety of types of devices. It is therefore intended that the invention not be limited by the discussion of specific embodiments.

Additional objects, advantages, aspects and features of the present invention will become apparent from the description of preferred embodiments, set forth below, which should be taken in conjunction with the accompanying drawings, a brief description of which follows.

### BRIEF DESCRIPTION OF THE DRAWING

The foregoing aspects and the attendant advantages of the present invention will become more readily appreciated by reference to the following detailed description, when taken in conjunction with the accompanying drawings, wherein:

FIGS. 1A-1B are perspective views of a first embodiment of the present invention as an AC power to cell phone cradle accessory that includes an AC-to-DC converter module to obtain power from an AC source and a cradle accessory module for receiving a cell phone, where FIG. 1A is a perspective view of an assembled cell phone accessory, and FIG. 1B is an exploded perspective view;

FIGS. 2A-2C are views of a second embodiment of the present invention as an AC power to DC cord accessory having the converter module of the first embodiment and a DC cord accessory module to provide DC power, where FIGS. 2A and 2B are perspective views, and FIG. 2C is a side view of an assembled cell phone accessory;

FIG. 3 is a perspective view of a third embodiment of the present invention as a DC power to cell phone cradle accessory having a DC-to-DC converter module to obtain power from a DC source and a cradle accessory module for receiving a cell phone;

FIG. 4 is a perspective view of a fourth embodiment of the present invention as an AC power to cell phone cradle accessory having an AC-to-DC converter module to obtain power from an AC source and the cradle accessory module of the third embodiment;

FIG. 5 is a perspective view of a fifth embodiment of the present invention as a DC power to cell phone plug accessory having a converter module of the third embodiment and a DC cord accessory module to provide DC power to a cell phone plug; and

FIG. 6 is a perspective view of a sixth embodiment of the present invention as an AC power to cell phone desk charger accessory having a converter module of the fourth embodiment and a DC cord accessory module plugged into a cell phone desk charger unit.

Reference symbols are used in the Figures to indicate certain components, aspects or features shown therein, with reference symbols common to more than one Figure indicating like components, aspects or features shown therein.

### DETAILED DESCRIPTION OF THE INVENTION

To facilitate its description, the following discussion will describe the invention in terms of device configuration for powering cell phones or cell phone-related devices from specific power sources. It will be understood to those of skill in the art, however, that the invention also may be used with other power systems or may be used to provide power to other electronic devices such as other cell phone accessories, to portable computers or record keeping devices, or to other mobile or fixed electronic devices. The invention should therefore not be taken as limited except as provided in the attached claims.

The present invention provides an electrical and mechanical connect between a source of power and a powered device, which may include, but is not limited to, a cell phone, a cell phone battery, or cell phone accessory such as a speaker. Power is obtained from a source such as a standard AC power receptacle, a standard DC power receptacle, or a DC receptacle normally intended for use as a cigarette lighter, as is commonly found in an automobile. Power is provided to the powered device after power conversion and is delivered to the powered device and through a connection that may be one of a variety of different manufacturers and often model specific electrical and mechanical connections.

As shown in the various embodiments, the present invention provides a system of cell phone accessories formed by the combination of interchangeable modules that each accomplish some or all of the electrical or mechanical functions of a cell phone accessory. In particular, accessories according to the present invention are composed of a conversion module and an accessory module, where each has one of a mating pair of connectors. The conversion module has a portion for mating with a power receptacle, conversion electronics, and one of the mating pair of connectors for providing power usable by a powered device. The accessory module has the other of the pair of mating connectors to receive power for the powered device and an assembly for further connection to a cell phone, charging stand, speaker, or other accessory device. The pair of mating connectors provides mechanical support for the accessory module and converter module, including support for the weight of the accessory module and any cell phone or accessory attached thereto. This support is provided by an interconnecting or interconnecting and locking components of each of the pair of mating connectors. The pair of connectors thus can slidably or lockingly engage when connected.

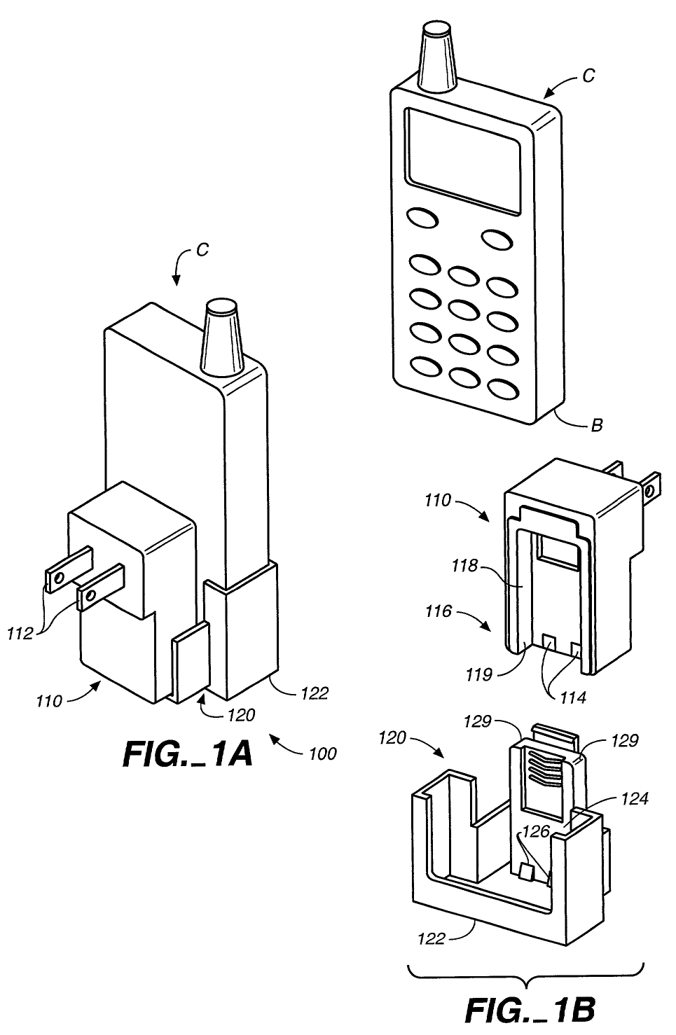

The present invention will now be described in more detail with reference to the Figures. FIGS. 1A-1B are perspective views of a first embodiment of the present invention as an AC power to cell phone cradle accessory 100 having an AC-to-DC converter module 110 to obtain power from an AC source (not shown), and a cradle accessory module 120 for receiving a cell phone C. FIG. 1A is a perspective view of an assembled accessory 100, and FIG. 1B is an exploded view of the accessory, showing converter module 110 and accessory module 120. As noted, the present invention provides cell phone accessories having interchangeable converter modules and accessory modules, and thus the present invention is directed to the individual modules, as well as their combination as shown herein. Accessory 100 includes a cradle 122 to accept cell phone C and a pair of prongs 112 protruding from converter module 110, where the prongs form a plug for an AC power receptacle (not shown). Cell phone C is shown throughout the Figures and described herein for illustrative purposes only, and is not meant to be a limiting feature of the invention.

FIG. 1B shows the accessory 100 as separate and separable modules 110 and 120. Converter module 110 includes power conversion electronics (not shown) that accept power from prongs 112 and coverts the power into a voltage and waveform compatible with a cell phone C. Cell phone C has contacts (not shown) located near a bottom cell phone portion B. A pair of output contacts 114 located near a lower end 116 of converter module 100 provide the output of the power conversion electronics that are internal to the converter module. Converter module 110 has a slide mount 118 with two edge 119 located on the opposite of the converter module from prongs 112. Thus slide mount 118 is positioned away from the receptacle into which prongs 112 mate.

Alternatively, connections to a cell phone could be made through a cell phone adaptor that fits about the phone, as in a clip adaptor, and also routes conductive members to portion B to facilitate the use of accessory module 120.

Converter module 110 provides a mechanical and electrical interface between the power receptacle and accessory adaptor 120. In general, converter electronics disposed between prongs 112 and output contacts 114 are adapted to convert the power from the source conditions a DC power of 5 to 26 volts. Converter module 110 has a U.S. standard plug for 110 VAC, and corresponding electronics to convert the power to a low voltage DC signal, as known in the art. Thus there may be a plurality of converter modules, each having converter electronics and prongs or plugs for a given source power. An alternative embodiment, useful for travel to different countries, would provide one or more plugs or prongs for mating with receptacles of different standards, and electronics that can be switched to respond to the differing input conditions. The switching could either be automatic and internal to the electronics based in the input power conditions, could be the result of manually setting a switch from the outside of a converter module, or by some other means.

Accessory module 120 has a pair of contacts 126 for mating with a cell phone placed into the cradle, and a slide mount 124 having edges 129 that mate with edges 119 of slide mount 118 of the converter module, and a set of spring clips to mate with electrical contacts with contacts 114.

Accessory 100 is easily assembled from converter module 110 and accessory module 120 by slidably engaging the mutually interlocking, slidable edges 119 and 128. Specifically, slide mount 128 of accessory module 120 slides upward into slide mount 118 of converter module 110, with edges 119 and 128 overlapping. When slide mounts 118 and 124 are fully engaged, spring clips (not shown) electrically engage contacts 114 to provide an electrical connection between prongs 112 and contacts 126. In addition, this configuration provides mechanical support to allow accessory 100 to act as unit. Prongs 112 of accessory 100 thus assembled can be plugged into a receptacle. When the receptacle is powered, converter electronics within converter module 110 provide power of the proper voltage and waveform at contacts 114, which are connected to contacts 126 through the assembled modules 110 and 120. A cell phone can then be placed in cradle 122, powering the cell phone. In addition, accessory 100 is configured such that both the weight of the accessory and the cell phone are supported by prongs 112 and the placement of converter module 110 against the receptacle to support the cell phone.

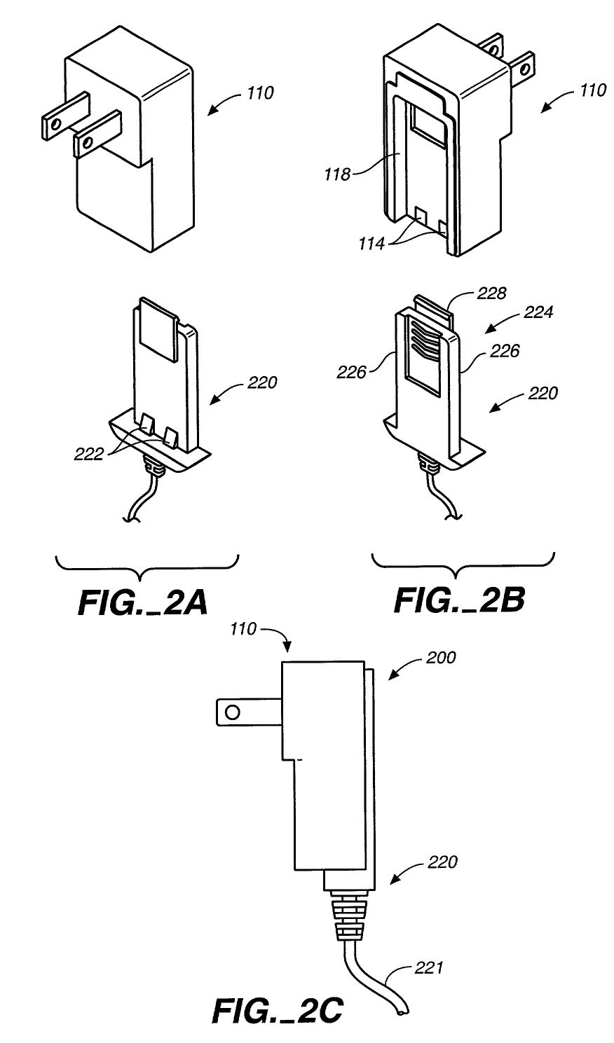

The use of mechanically and electrically equivalent slide mounts and converter modules that deliver a specified voltage regardless of the source power conditions allows for interchangeability of converters and accessory modules. FIGS. 2A-2C are views of a second embodiment of the present invention as an AC power to DC cord accessory 200 having the converter module 110 of the first embodiment and a DC cord accessory module 220 to provide DC power by a cord 221. In particular, FIGS. 2A and 2B are perspective views of converter module 110 and accessory module 220, and FIG. 2C is a side view of an assembled cell phone accessory 200.

Accessory module 200 has a slide mount 224 with a pair of edges 226, a locking mechanism 228, and spring clip contacts 222 that are similar to slide mount 124. Cord 221 can be a straight cord, a coiled cord, a retractable cord, or some other configuration. The end of cord 221 that is not shown can have any one of a number of standard or specialized plugs for delivering DC power. One particularly useful plug is one that can plug directly into a cell phone or other accessory. Another useful plug is a standard power plug that can be used to power accessories from standard power receptacles.

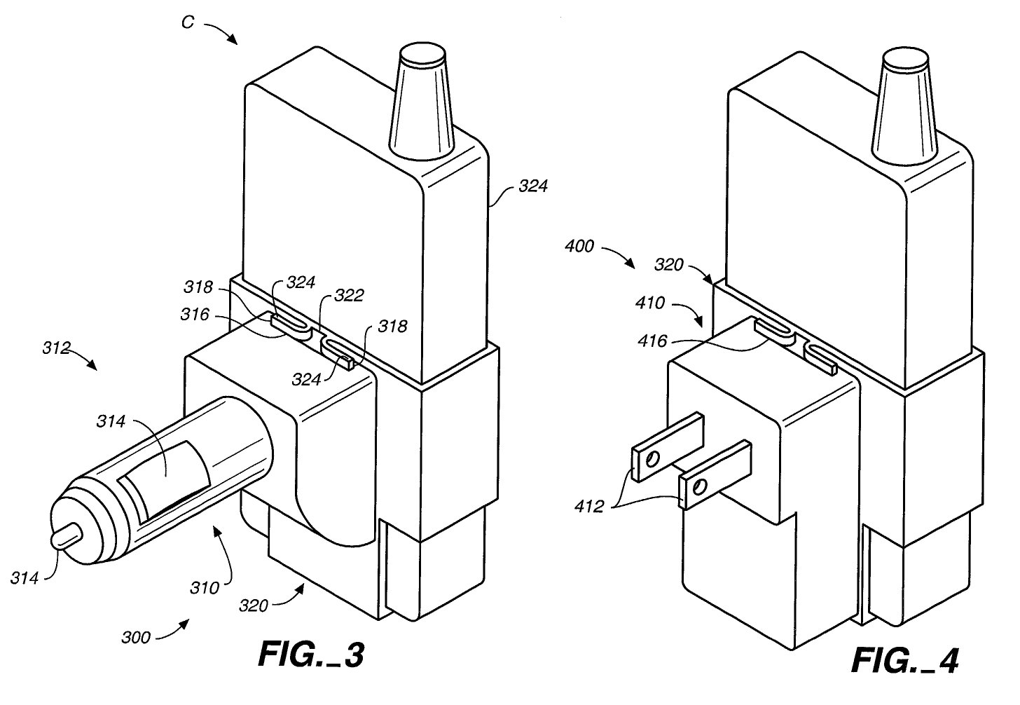

Alternative converter module to accessory module mating system is shown in FIGS. 3-6. FIG. 3 is a perspective view of a third embodiment of the present invention as a DC power to cell phone cradle accessory 300. Accessory 300 includes a DC-to-DC converter module 310 and a cradle accessory module 320 for receiving a cell phone C. Converter module 310 has an end 312 for insertion into a cigarette lighter receptacle (not shown) having a set of contacts 314 to mate with the contacts within the receptacle. Also included in converter module 310 are DC-to-DC conversion electronics to produce power usable for a cell phone and for a slide mount 316 having edges 318 and output contacts for the conversion electronics (not shown).

Accessory module 320 is adapted to fits around cell phone C and has a slide mount 322 with edges 324 that forms the mate to slide mount 316. Accessory 300 is easily assembled from converter module 310 and accessory module 320 by slidably engaging the mutually interlocking, slidable edges 318 and 324. Specifically, slide mount 322 of accessory module 320 slides downward into slide mount 318 of converter module 310, with edges 318 and 324 overlapping. When slide mounts 316 and 322 are fully engaged spring clips in accessory module 320 electrically engage contacts of converter module 321 to provide an electrical connection between contacts 314 and contacts provide for mating with the cell phone (not shown). Accessory 300 thus assembled can be plugged into a receptacle. When the receptacle is powered, converter electronics within converter module 310 provide power of the proper voltage within accessory module 320. A cell phone can then be placed in accessory module 320, powering the cell phone. In addition, accessory 300 is configured such that both the weight of the accessory and the cell phone are supported by end 412 and the placement of converter module 310 against the receptacle to support the cell phone.

A perspective view of a fourth embodiment of the present invention is shown in FIG. 4 is as an AC power to cell phone cradle accessory 400 having an AC-to-AC converter module 410 connected to accessory module 320 of the third embodiment. Converter module 410 includes prongs 412 adapted to mate with a power receptacle, conversion electronics, and slide mount 416 with output contacts for the conversion electronics (not shown). Slide mount 416 is functionally equivalent to slide mount 316, allowing for interchangeability of converter modules. Alternatives to converter module 410 include three-prong U.S. plugs and plugs and conversion electronics for other national standards, and travel adapters with interchangeable prongs or plugs and conversion electronics.

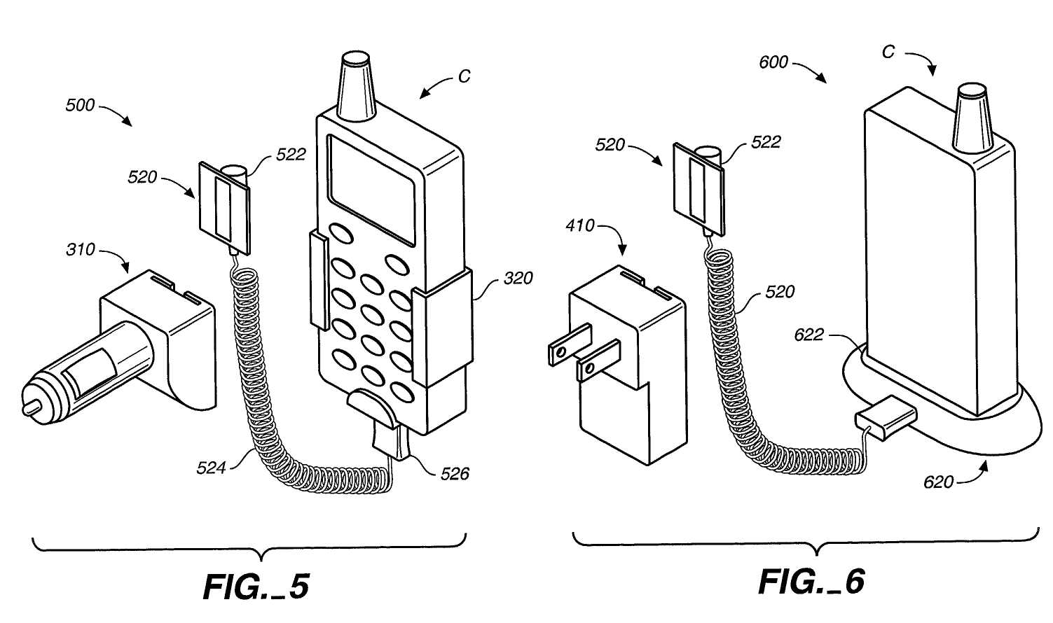

FIG. 5 is a perspective view of a fifth embodiment of the present invention as a DC power to cell phone plug accessory 500 having converter module 310 of the third embodiment and a coiled cord accessory module 520. Accessory module 520 includes a slide mount 522 and a phone plug 526 connected by a coiled cord 524. Slide mount 522 provides the same physical and electrical connections as does slide mount 322. Cord 524 can be of any convenient length, and alternatively can be straight or include a retraction mechanism. Cradle module 320 is shown placed about the phone, but serves no electrical purpose in this embodiment. Phone plug 526 passes through a hole in cradle accessory module and into cell phone C.

A sixth embodiment of the present invention is shown in FIG. 6 as a perspective view of an AC power to cell phone desk charger accessory 600 that includes converter module 410 of the fourth embodiment, coiled cable accessory module 520 of the fifth embodiment, and an additional accessory module shown as a desk charger accessory module 620. This arrangement allows users to both talk and charge in an office environment. Accessory module 620 has an opening 622 to accept and support a cell phone. Accessory module 620 also has electrical contacts to mate with those of a cell phone placed in opening 622. When connected as shown in FIG. 6, AC converter 410 and coiled accessory module 520 provide power to desk charger 620.

The invention has now been explained with regard to specific embodiments. Variations on these embodiments and other embodiments may be apparent to those of skill in the art. It is therefore intended that the invention not be limited by the discussion of specific embodiments. It is understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A modular system for accepting power from a receptacle of a power source and providing power of specified characteristics to an electronic device, said system comprising:
a converter module including a housing, where said housing supports
a plug adapted to mate with the receptacle,
a first connector, and
electronics disposed between said plug and said first connector, where said electronics are adapted to convert power from the mated plug to the specified power characteristics, and
an accessory module having
a second connector adapted to mate with and be supported by said first connector, and
an assembly adapted to mate with the electronic device.

2. The modular system of claim 1, wherein said electronic device is a cellular telephones or accessories thereof.

3. The modular system of claim 1, wherein the power source is an AC power source, and wherein said converter is an AC-to-DC power converter.

4. The modular system of claim 1, wherein the power source is a DC power source, and wherein said converter is a DC-to-DC power converter.

5. The apparatus of claim 4, wherein said DC power source is provided by an automobile electrical system.

6. The modular system of claim 1, wherein said electronic device is a cellular telephones or accessories thereof, and wherein said accessory module is selected from the group consisting of a phone cradle to support and provide power to a cell phone, a straight cord having a telephone-compatible connector, a retractable cord having a telephone-compatible connector, a coiled cord having a telephone-compatible connector, a speaker, or any combination thereof.

7. The modular system of claim 1, wherein said first connector and said second connector slidably engage.

8. The modular system of claim 8, wherein said first connector and said second connector lockably engage.

9. The modular system of claim 1, wherein said electronic device is a cellular telephones or accessories thereof, and wherein said accessory module is a phone cradle to support and provide power to a cell phone, and wherein the weight of a cell phone placed on said phone cradle is supported is supported by said plug.

10. A converter module connectable to a power receptacle of a power source and an accessory module having a second connector and adapted to provide power of specified characteristics to an electronic device, said converter module comprising:
a housing to support
a plug adapted to mate with said receptacle,
a first connector, and
electronics disposed between said plug and said connector, where said electronics are adapted to convert the power from said mated plug to the specified power characteristics, and where said connector is adapted to mate with and support the second connector of one of a plurality of accessory modules.

11. The converter module of claim 11, wherein said electronic device is a cellular telephone or accessories thereof.

12. The converter module of claim 11, wherein the power source is an AC power source, and wherein said converter is an AC-to-DC power converter.

13. The converter module of claim 11, wherein the power source is a DC power source, and wherein said converter is a DC-to-DC power converter.

14. The apparatus of claim 13, wherein said DC power source is provided by an automobile electrical system, and wherein said plug adaptable for mating with an automobile cigarette lighter.

15. The converter module of claim 11, wherein said first connector and said second connector slidably engage.

16. The converter module of claim 15, wherein said first connector and said second connector lockably engage.

17. An accessory module to accept power at specified characteristics to an electronic device, said accepted power provide by a converter module having a plug adapted to receive power from a receptacle of a power source, where said converter module includes a housing to support a plug adapted to connect to said receptacle, a first connector, and electronics disposed between said plug and said first connector to convert the power from a plug connected to the receptacle, said accessory module comprising:
a second connector adapted to mate with and be supported by said first connector; and
an assembly adapted to mate with the electronic device.

18. The accessory module of claim 17, wherein said electronic device is a cellular telephones or accessories thereof.

19. The accessory module of claim 17, wherein said electronic device is a cellular telephones or accessories thereof, and wherein said accessory module is selected from the group consisting of a phone cradle to support and provide power to a cell phone, a straight cord having a telephone-compatible connector, a retractable cord having a telephone-compatible connector, a coiled cord having a telephone-compatible connector, a speaker, or any combination thereof.

20. The converter module of claim 17, wherein said first connector and said second connector slidably engage.

21. The converter module of claim 20, wherein said first connector and said second connector lockably engage.

22. The converter module of claim 17, wherein said electronic device is a cellular telephones or accessories thereof, and wherein said accessory module is a phone cradle to support and provide power to a cell phone, and wherein the weight of a cell phone placed on said phone cradle is supported is supported by said plug.

23. A method for providing interchangeably of accessories for cellular telephones and power sources comprising:
providing a connector to a power converter that is connectable to one of a plurality of cellular telephone accessories.

24. A method for providing interchangeably of accessories for cellular telephones and power sources comprising:
providing a connector to a cellular telephone accessory module power that is connectable to one of a plurality of power converters.
